(19) United States
(12) Patent Application Publication
(10) Pub. No.: US 2024/0336538 A1
(43) Pub. Date: Oct. 10, 2024

(54) BIOCHAR BASED FERTILIZER AND ASSOCIATED SYSTEMS AND METHODS

(71) Applicant: SOUTH DAKOTA BOARD OF REGENTS, Pierre, SD (US)

(72) Inventors: Lin Wei, Brookings, SD (US); Zhisheng Cen, Brookings, SD (US); Cheng Zhang, Brookings, SD (US); Yajun Wu, US, SD (US)

(21) Appl. No.: 18/580,985

(22) PCT Filed: Jul. 21, 2022
(86) PCT No.: PCT/US2022/037779

§ 371 Date: Jan. 19, 2024

Related U.S. Application Data
(60) Provisional application No. 63/224,358, filed on Jul. 21, 2021.

(51) Int. Cl. C05D 9/00; C05F 7/00; C05G 1/00; C05G 3/40; C05G 5/30

(52) U.S. Cl. CPC C05D 9/00; C05F 7/005; C05G 1/00; C05G 3/40; C05G 5/37

(57) ABSTRACT

Disclosed herein is a biochar controlled release fertilizer composition. Various embodiments include biochar and one or more nutrients encapsulated in a biodegradable polymer composite. Further embodiments of the controlled release fertilizer composition include one or more of alginate, kaolin, and waste water sludge. The nutrients of the fertilizer may be released such as to be available at the time needed for crop growth while minimizing waste and potentially harmful environmental effects.

### CROSS-REFERENCE TO RELATED APPLICATION(S)

This application claims priority to International PCT Application No. PCT/US2022/037779, filed on Jul. 21, 2022, which claims priority under 35 U.S.C. § 119 (e) to U.S. Provisional Application 63/224,358, filed Jul. 21, 2021, and entitled “Biochar Based Fertilizer and Associated Systems and Methods,” which are hereby incorporated by reference in their entireties for all purposes.

### GOVERNMENT SUPPORT

This invention was made with government support under Grant No. 3FK640, awarded by the USDA NIFA. The government has certain rights in the invention.

### FIELD

The various embodiments herein relate to agricultural fertilizers and methods of production and use thereof.

### BACKGROUND

The yields of many crops (e.g. corn, wheat, rice) heavily rely on uptake of different nutrients, such as nitrogen (N), phosphorus (P), and/or potassium (K), from the soil. However, the demand of nutrients varies significantly at different growth stages. For example, a corn plant needs very little nitrogen (<0.5 lb/acre per day) in the first 3 weeks after seeding, however, nitrogen uptake of the plant increases exponentially starting from the fourth week until the 8th week, with an average of about 3.3 lb/acre per day and a highest uptake of about 5.4 lb/acre per day. More than 70% of nitrogen uptake occurs within 25-30 days of the middle vegetative stage. Much less nitrogen (<0.6 lb/acre per day) is needed in the later period of reproductive to mature stages.

Currently, the practice of conventional fertilization is poorly synchronized for nitrogen application and the demands of growing corn. About 75% of nitrogen fertilizer applications are made before planting in the United States. Most of the nitrogen fertilizers that are applied are dissolved in water instantly or otherwise released into soil quickly. Hence, the timing of nitrogen availability does not match the nitrogen demands of corn growth. The gap time between nitrogen application and the active uptake by the corn provides numerous opportunities for nitrogen loss from leaching, clay fixation, immobilization, denitrification, and volatilization. For example, the nitrogen applied may be lost to the groundwater through leaching or end up in the nearby surface waters via surface runoff or directly via tile drainage bypassing stream buffers. In addition, significant fractions of the applied nitrogen are lost into the air through emission of ammonia (NH₃), nitrous oxide (N₂O), and nitric oxide (NO). Unfavorably, the ammonia emission contributes to water eutrophication and land acidification when redeposited on the earth's surface through rain. Further, nitrous oxide is a potent greenhouse gas and plays a key role in tropospheric ozone chemistry.

To increase nitrogen availability and accessibility, it is common to use multiple applications of nitrogen fertilizers or extra nitrogen fertilizers during a single growing season, applied by heavy machine systems along with manual labor. This common approach directly results in low efficiency and high production costs in view of the high cost of such machinery and labor. Current efficiency of conventional nitrogen fertilizers (e.g. urea and ammonium sulfate) in agricultural practices is low, fluctuating from 30 to 40%. That is, approximately 60-70% of nitrogen fertilizers are currently wasted due to volatilization into air, run-off, and/or leaching into water systems. The low efficiency of nitrogen fertilizer has resulted in not only high production costs but also serious environmental problems, such as greenhouse gas (N₂O) emission, algal blooms, oxygen depletion, fish kills, and loss of biodiversity in surface water due to eutrophication and/or pollution.

Therefore, there is a need in the art for more efficient and environmentally friendly fertilizers.

### BRIEF SUMMARY

Discussed herein are various biochar-based controlled release fertilizers.

In Example 1, a controlled release fertilizer comprising a biochar mixture, one or more nutrients, and a biodegradable polymer composite coating encapsulating the biochar mixture and the one or more nutrients.

Example 2 relates to the controlled release fertilizer according to Example 1, wherein the controlled release fertilizer comprises a plurality of particles.

Example 3 relates to the controlled release fertilizer according to Example 2, wherein the plurality of particles each have a diameter between about 0.1 and about 8.0 mm.

Example 4 relates to the controlled release fertilizer according any one of Examples 1-3, wherein the biochar mixture is present in an amount of from about 10% to about 90% by weight of the controlled release fertilizer.

Example 5 relates to the controlled release fertilizer according to any one of Examples 1-4, wherein the biodegradable polymer composite coating comprises one or more of a synthetic polymer or natural polymer comprising bio-resins, lignin, cellulose, nanocellulose, polylactic acid (PLA), polycaprolactone (PCL), polyglycolide (PGA), polybutylene succinate (PBS), bio-asphalt, and bio-oil residues.

Example 6 relates to the controlled release fertilizer according to any one of Examples 1-5, wherein the biodegradable polymer composite coating is present in an amount of from 0.1% to about 50% by weight of the controlled release fertilizer.

Example 7 relates to the controlled release fertilizer according to any one of Examples 1-6, wherein the biodegradable polymer composite coating comprises a synthetic polymer in an amount of from about 1% to about 90% by weight, a natural polymer in an amount of from about 1% to about 80% by weight, and one or more additives in an amount of from 0% to about 50% by weight of the biodegradable polymer composite coating.

Example 8 relates to the controlled release fertilizer according to any one of Examples 1-7, further comprising one or more of alginate, kaolin, and waste water sludge.

Example 9 relates to the controlled release fertilizer according to Example 8, wherein the alginate is present in an amount of from 0% to about 30% by weight, wherein the kaolin is present in an amount of from about 0% to about 25% by weight, or wherein the waste water sludge is present in an amount of from about 0% to about 60% by weight of the controlled release fertilizer.

Example 10 relates to the controlled release fertilizer according to any one of Examples 1-9, wherein the one or more nutrients comprises one or more of nitrogen, potassium, and phosphorus.

Example 11 relates to the controlled release fertilizer according to Example 10, wherein the nitrogen is present in an amount of from about 0% to about 55% by weight, wherein the potassium is present in an amount of from 0% to about 65% by weight, and/or wherein the phosphorus is present in an amount of from 0% to about 40% by weight of the controlled release fertilizer.

Example 12 relates to the controlled release fertilizer according to any one of Examples 1-11, wherein the release rate of the one or more nutrients from the controlled release fertilizer depends on one or more conditions of a soil, the one or more conditions of the soil comprising moisture content, temperature, and/or pH value.

Example 13 relates to the controlled release fertilizer according to any one of Examples 1-12, further comprising a biosolid in an amount of from 0% to about 60% by weight of the controlled release fertilizer.

In Example 14, a method of making a biochar based controlled release fertilizer comprises mixing together a biochar mixture and one or more nutrients and encapsulating the biochar and the one or more nutrients in a biodegradable polymer composite.

Example 15 relates to the method according to Example 14, further comprising pelletizing the biochar mixture and the one or more nutrients.

Example 16 relates to the method according to any one of Examples 14-15, wherein the biodegradable polymer composite comprises one or more of a synthetic or natural polymer comprising bio-resins, lignin, cellulose, nanocellulose, polylactic acid (PLA), polycaprolactone (PCL), polyglycolide (PGA), polybutylene succinate (PBS), bio-asphalt, and bio-oil residues.

Example 17 relates to the method according to any one of Examples 14-16, wherein the one or more nutrients comprises one or more of nitrogen, potassium, and phosphorus.

Example 18 relates to the method according to any one of Examples 14-17, further comprising mixing one or more of alginate, kaolin, and waste water sludge with the biochar mixture and the one or more nutrients.

In Example 19, a method of using a biochar based controlled release fertilizer comprises applying the controlled release fertilizer according to any one of Examples 1-13 to soil.

Example 20 relates to the method according to Example 19, wherein the controlled release fertilizer provides a controlled release of the one or more nutrients from the controlled release fertilizer depending on one or more conditions of the soil, wherein the one or more conditions of the soil comprises moisture content, temperature, and/or pH value.

### BRIEF DESCRIPTION OF THE DRAWING

FIG. 1 is a process diagram for making a fertilizer, according to one exemplary embodiment.

FIG. 2 is a diagram of how the biochar-based fertilizer may be applied in fields for crop growth.

FIG. 3 is a graph showing the cumulative nitrogen release of various biochar-based fertilizer formulations with respect to time in days.

FIG. 4 is a bar graph showing the corn grain yield of various fertilizer treatments. Within FIG. 4, Control=without addition of fertilizer; AS=ammonium sulfate; CCRF=commercial control release fertilizer; BCRF=Biochar-based controlled release fertilizer.

FIG. 5 is a bar graph showing the percent nitrogen loss of different fertilizer treatments due to leaching. Within FIG. 5, AS=ammonium sulfate; CCRF=commercial control release fertilizer; BCRF=Biochar-based controlled release fertilizer.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### DETAILED DESCRIPTION

Disclosed herein are various controlled release fertilizers. In accordance with certain implementations, various of the disclosed controlled release fertilizer compositions include biochar and may be used in sustainable agriculture for cultivation of corn, wheat, rice, potato, soybean, and other crops. According to various embodiments, the controlled release fertilizer composition is biocompatible and as such does not leave harmful residues after fertilization.

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, mass, volume, and time. Further, given solid and liquid handling procedures used in the real world, there is certain inadvertent error and variation that is likely through differences in the manufacture, source, or purity of the ingredients used to make the compositions or carry out the methods and the like. Whether or not modified by the term “about,” the claims include equivalents to the quantities.

The methods and compositions of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

The term “weight percent,” “wt. %,” “wt-%,” “percent by weight,” “% by weight,” and variations thereof, as used herein, refer to the concentration of a substance as the weight of that substance divided by the total weight of the composition and multiplied by 100.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Biochar is a granular carbon substance produced by pyrolysis or thermal decomposition of organic matter in the absence of oxygen. It is highly porous and environmentally safe.

Various embodiments of the biochar-based controlled release fertilizer (“BCRF”) composition disclosed and contemplated herein provides long-term benefits to soil health and the environment due to the biochar mixture and its residues that may improve soil structure and carbon sequestration in soil while reducing nutrient run off and/or leaching.

According to one implementation, the fertilizer composition includes biochar and at least one nutrient for stimulating plant growth and/or health. Alternative compositions can also include, in addition to the biochar and at least one nutrient, at least one of alginate, kaolin, and/or wastewater sludge. In addition, further implementations can include a known, conventional fertilizer. In some embodiments, the known fertilizer is used in place of the at least one nutrient.

In accordance with certain embodiments, any composition herein can take the form of particles. Alternatively, the composition can be in the form of liquid or gel. Further, in various implementations, the composition can be encapsulated with a coating made up of a biodegradable polymer. The biodegradable polymer can include at least one organic polymer and/or at least one inorganic mineral. For example, the biodegradable polymer can be made up of a bio-resin, lignin, cellulose/nanocellulose, polylactic acid (“PLA”), bio-asphalt, a bio-oil residue, or the like. The selection of the at least one biodegradable polymer can depend on the crop species and target yield. According to certain implementations, the coating can slow the release of the components of the composition encapsulated therein, as will be described in additional detail below.

The BCRF composition, in accordance with certain implementations, can control the nitrogen (N), phosphorus (P), and potassium (K) (collectively “NPK”) and/or other nutrient release profiles to correspond to plant uptake to improve use efficiency of the fertilizer and reduce costs by properly formulating and designing BCRF composition and structure. In various embodiments of the BCRF composition, the releasing patterns of NPK and other nutrients are controlled by integration of the water solubility, morphology, and/or microstructure of the BCRF composition. In certain embodiments as mentioned above, the biodegradable coating may also be a factor in controlling the release of nutrients to meet the demands of crop growth. That is, the NPK releasing rate and timing can be tailored and controlled by adjusting the water solubility, morphology, and/or microstructure of the BCRF composition and/or the morphology and/or microstructure of the coating.

In various embodiments disclosed and contemplated herein, all components of the BCRF composition are bio-based and biocompatible. As such, there are no harmful residues left behind after use the composition in fields. Further, in certain embodiments, the biochar in the composition, along with the optional waste water sludge component, can act as a conditioner for improving soil health.

A still further advantage of the BCRF composition disclosed and contemplated herein is that the composition may be applied to fields using existing and known agricultural machinery, systems, and equipment without significant changes. As such, no specialized equipment is needed further improving efficiency in use of the various composition embodiments disclosed herein.

As mentioned above, in various embodiments, in addition to the biochar, the BCRF composition can include one or more of alginate, kaolin, and/or wastewater sludge in addition to the at least one nutrient. As also discussed above, in certain embodiments, instead of at least one nutrient, the BCRF composition can include a conventional fertilizer to provide the necessary nutrients. For example, the one or more conventional fertilizers used in any BCRF composition herein may contain one or multiple nutrients such as nitrogen (N), phosphorus (P), and/or potassium (K). The nutrients contained in the BCRF composition and their amounts/concentrations may be varied according to the demand of crop species and target yield. For example, in a BCRF composition intended to enhance corn or soybean growth, the nitrogen concentration may vary from about 0% to about 55% by weight, about 0% to about 45% by weight, about 0.1% to about 45% by weight, about 1% to about 40% by weight, about 1% to about 35% by weight, or about 1% to about 25% by weight, while the phosphorus may vary from about 0% to about 40% by weight, about 0% to about 35% by weight, about 0% to about 25% by weight, about 0.1% to about 40% by weight, about 0.1% to about 35% by weight, or about 0.1% to about 25% by weight, and the potassium may vary from about 0% to about 65% by weight, about 0% to about 60% by weight, about 0% to about 40% by weight, about 0% to about 20% by weight, about 0.1% to about 65% by weight, or about 0.1% to about 60% by weight of the BCRF composition.

According to certain embodiments as mentioned above, the BCRF composition, including the composition in particle form, can be coated with a biodegradable polymer composite using any known spraying or dipping methods, as would be recognized by those of skill in the art. Coating the BCRF composition with organic polymers or inorganic minerals can provide a controlled release feature by slowing release of nutrients and other components of the composition upon application.

The biodegradable polymers can include, but is not limited to, one or more of synthetic and/or natural polymers, such as polycaprolactone (PCA), polylactic acid (“PLA”), proteins, polysaccharides, bio-resin, lignin, cellulose/nanocellulose, bio-asphalt, bio-oil residue, or the like, as would be appreciated. The selection of one or more of the components of the biodegradable polymer composite may depend on the crop species and target yield. In various embodiments, the biodegradable polymers can be either hydrophobic (e.g. PLA, bio-oil-derived biobinder, bio-resins, or the like as would be appreciated), hydrophilic (e.g. lignin, cellulose, nanocellulose fiber (CNF), crystal nanocellulose (CNC), or the like as would be appreciated), or any combination thereof. The biodegradable polymer composite can be varied depending on the demand of the specific crop growth. The selected biodegradable polymer composite may consist of one or multiple polymers, such as, for example, poly(glycolic acid) (PGA), poly(lactic acid) (PLA) and their copolymers—poly(lactic-co-glycolide) (PLGA) or poly(I-lactic acid) (PLLA), polydioxanone (PDO), poly(caprolactone) (PCL), polybutylene succinate (PBS), or the like as would be appreciated. In some aspects, the coating may be further referred to herein as a “biodegradable polymer composite coating.”

According to certain embodiments, the concentration of the biodegradable polymer composite coating may be present on the surfaces of the BCRF composition particles in an amount from about 0.1% to about 50% by weight, about 0.1% to about 45% by weight, about 0.1% to about 40% by weight, about 0.1% to about 35% by weight, about 0.1% to about 30% by weight, about 0.5% to about 35% by weight, or about 1% to about 30% by weight.

According to further embodiments, the release profile of the BCRF composition may be controlled depending on the needs of the nutrient release and growth season period of the specific crop type. The release profile may be controlled by adjusting the ratio of the components within the biodegradable polymer composite coating. In some embodiments, the biodegradable synthetic polymers may vary within the biodegradable polymer composite coating from about 1% to about 90% by weight depending upon the type of crop. Some examples of the biodegradable synthetic polymers may include, but are not limited to, PLA, PCL, PGA, or PBS. In further embodiments, biodegradable natural polymers may vary within the biodegradable polymer composite coating from about 1% to about 80% by weight depending upon the type of crop. Some examples of natural polymers may include, but are not limited to, animal or plant proteins, polysaccharides (i.e., starch, cellulose), poly ß-hydroxyalkanoate (PHA), or poly hydroxybutyrate (PHB). In still further embodiments, optional additives may vary within the biodegradable polymer composite coating from about 0% to about 50% by weight depending upon the type of crop. Examples of the optional additives include, but are not limited to, solvents (i.e., ethanol, acetone, chloroform), or additional fillers (i.e., kaolin, clay, biochar).

As discussed above, the BCRF composition contains biochar, which is water absorbent and thus can improve water retention in soil and help crop roots grow. By improving water retention, the BCRF composition embodiments herein can significantly minimize nitrogen evaporation, surface run off, and/or leaching. By minimizing nutrient loss, use of a BCRF composition can reduce the use of fertilizer in the composition (and thus in the fields to which the composition is applied) and in turn also minimize fertilizer lost into air and/or water and thereby avoid or moderate eutrophication, algae blooming, oxygen deprivation, or other environmental impacts caused by nutrient invasion into the environment.

According to certain embodiments, the concentration of biochar included in the BCRF composition may depend on the nutrient release requirements for a specific crop growth. In further embodiments, the concentration of the biochar within the BCRF composition may vary between about 10% to about 90% by weight of the composition. In further embodiments, the concentration of the biochar within the BCRF composition may be present in an amount of from about 15% to about 85% by weight of the composition, or from about 20% to about 80% by weight of the composition.

As mentioned above, in certain embodiments, the BCRF composition can optionally include alginate, kaolin, and/or wastewater sludge. The addition of alginate, kaolin, and/or wastewater sludge can help to improve the BCRF composition water retention and soil microbe activity after the composition is applied in field.

According to certain embodiments, the concentration of alginate may be present in an amount of from about 0% to about 30% by weight, about 0% to about 25% by weight, about 0% to about 20% by weight, between about 0.1% to about 30% by weight, between about 0.1% to about 25% by weight, or between about 0.1% to about 20% by weight, while the concentration of kaolin may be present in an amount of from about 0% to about 25% by weight, about 0% to about 20% by weight, about 0% to about 15% by weight, about 0.1% to about 25% by weight, about 0.1% to about 20% by weight, or about 0.1% to about 15% by weight, and while the wastewater sludge may be present in an amount of from about 0% to about 60% by weight, about 0% to about 55% by weight, about 0% to about 50% by weight, about 0.1% to about 60% by weight, about 0.1% to about 55% by weight, or about 0.1% to about 50% by weight of the BCRF composition.

In some embodiments, the BCRF composition may optionally include biosolids, such as, for example, agricultural residues or food waste composts. According to certain embodiments, the optional biosolids may be present within the composition in an amount of from about 0% to about 70% by weight, about 0% to about 65% by weight, about 0% to about 60% by weight, about 0.1% to about 70% by weight, about 0.1% to about 65% by weight, or about 0.1% to about 60% by weight of the BCRF composition.

In these embodiments, the release of the nutrients to the crops from the composition can be controlled, providing nutrients to the crops as needed. That is, the timing of the release of nitrogen (N), phosphorus (P), potassium (K), and/or other important micronutrients, such as, for example, Boron (B), Zinc (Zn), Manganese (Mn), Iron (Fe), Copper (Cu), Molybdenum (Mo), and/or Chlorine (CI), can be controlled and/or tailored to the timing of their usage by the particular crops. This tailoring/customization of the nutrient release improves fertilizer efficiency and lowers operating costs. As a result, the use of any of the various BCRF composition embodiments disclosed or contemplated herein may then result in operational efficiencies. By controlling and only applying the amount of nutrients needed for the crop and releasing the nutrients over time as the crops need such nutrients, waste is reduced.

In some embodiments, the release rate of the one or more nutrients depends on soil conditions, such as, but not limited to, moisture content, temperature, and/or pH value. In some embodiments, the fertilizer compositions of the present disclosure may beneficially be referred to as a smart fertilizer. In examples, a smart fertilizer may be able to respond to the conditions of the soil such as moisture content, temperature, and/or pH value. When these parameters change, the nutrient release from the compositions may be modified by either increasing or decreasing the nutrient release rate.

For example, in some embodiments, as the moisture content of the soil increases, the release rate of nutrients from the BCRF composition may increase. Similarly, as the moisture content of the soil decreases, the release rate of nutrients from the BCRF composition may decrease. In some embodiments, as the temperature of the soil increases, the release rate of nutrients from the BCRF composition may increase. Similarly, as the temperature of the soil decreases, the release rate of nutrients from the BCRF composition may decrease. In further embodiments, as the pH value of the soil increases, the release rate of nutrients from the BCRF composition may increase. Similarly, as the pH value of the soil decreases, the release rate of nutrients from the BCRF composition may decrease. In certain embodiments, the release rate of the nutrients from the BCRF composition may be stable at a pH value of around 7. The ability of the BCRF compositions to alter nutrient release rate in response to various soil conditions provides benefits particularly due to varying weather conditions in which the crop fields may be subject to (i.e. rain, snow, etc.).

Further, the biochar in the composition may improve soil conditioning, soil water retention, and plant root growth. The biochar is good conditioner for soil health because its large surface area, porosity, and micropores can trap or catch organic matter and nutrients. The soil microbials can thrive inside biochar micropores and surfaces.

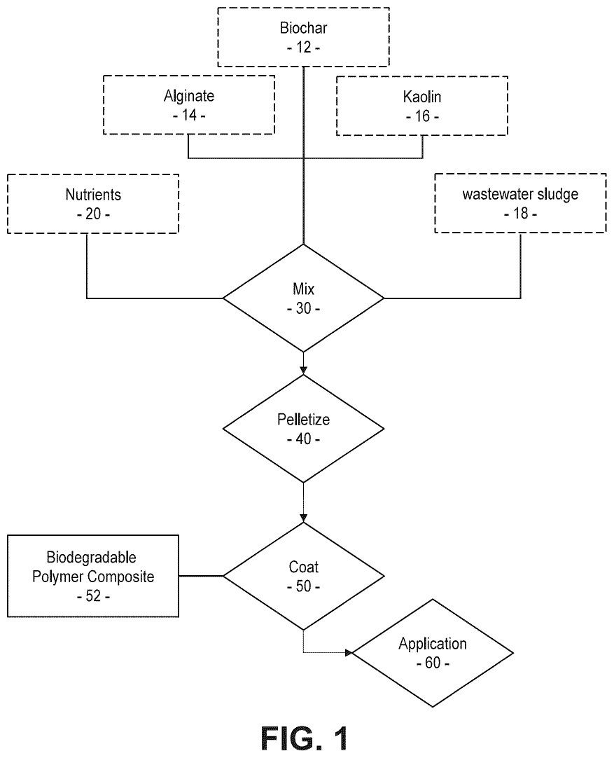

The composition embodiments herein can be made in the following manner. Turning now to FIG. 1, in various embodiments, the BCRF composition is fabricated by mixing 30 at least one nutrient (such as a one or more known liquid or solid conventional fertilizer or any other nutrient source 20 with a low-solubility mixture of biochar 12. Alternatively, this mixing 30 step can also include the addition and mixing of at least one of alginate 14, kaolin 16, and/or wastewater sludge 18 at different ratios as discussed throughout the disclosure herein.

According to certain embodiments, after the mixing 30, the resulting mixture of at least one nutrient 20 and biochar 12 (and, according to certain implementations, any one or more of the other optional components) is pelletized 40 into particles using a known pelletizer, as would be understood. In various embodiments, the resulting particles are small particles with diameters ranging from about 0.1-8 mm. Alternatively, instead of pelletization, the composition can be mixed in a liquid or gel form.

As discussed above, in accordance with various alternative embodiments, the resulting particles can also be coated 50 or encapsulated 50 with a layer of biodegradable polymer 52. In various embodiments, the biodegradable polymer 52 can be either hydrophobic (e.g. PLA, bio-oil-derived biobinder, bio-resins, or the like as would be appreciated), hydrophilic (e.g. lignin, cellulose, nanocellulose fiber (CNF), crystal nanocellulose (CNC), or the like as would be appreciated), or any combination thereof. The biodegradable polymer composite 52 can be varied depending on the demand of the specific crop growth. The selected biodegradable polymer composite 52 may consist of one or multiple polymers, such as, for example, poly(glycolic acid) (PGA), poly(lactic acid) (PLA) and their copolymers—poly(lactic-co-glycolide) (PLGA) or poly(I-lactic acid) (PLLA), polydioxanone (PDO), poly(caprolactone) (PCL), or the like as would be appreciated.

For example, when the BCRF composition is coated (step 50) with a polylactic acid composite 52, the nitrogen nutrients can be controlled at a rate that is synchronized with the nitrogen demand of corn plants for 50 days, which will significantly improve the availability and efficiency of nitrogen fertilizer while reducing nitrogen loss to the environment.

After the pelletizing step 40 (or the optional coating step 50), the BCRF particles are applied 60 to soil. Once the particles have been applied 60, the biodegradable polymer coating 52 can absorb moisture and swell while the core of the BCRF particles slowly dissolves and degrades, thereby slowly releasing the components of the BCRF composition (such as the nutrients 20) into the soil for uptake by plant roots. By applying 60 the BCRF composition at different depths of the soil with varying quantity and controlled releasing rate, the components (including the nutrients 20) and water in the BCRF composition particles become available as the crops need them.

The nutrient release rate of the various BCRF composition embodiments herein can be adjusted to meet the demands of crop growth while improving water availability by trapping moisture to the BCRF composition particles. As previously noted, application of the BCRF composition implementations disclosed and contemplated herein will not only improve fertilizer use efficiency, but also reduce nutrients leaching into groundwater, avoid surface run-off, and minimize harmful impacts on environment, ecosystem, and soil health.

Further, the BCRF composition embodiments disclosed and contemplated herein can increase fertilizer use efficiency while lowering the cost for crop production. The nutrient release rate and timing of the compositions herein are adjustable and controllable to the demands of crop growth by properly formulating and designing BCRF composition and coating structure. As such, less fertilizer is needed for the same yield of crop. Further, the BCRF composition disclosed and contemplated herein requires only one application in a growing season, and by only using one application in a season, production costs can be significantly reduced.

### EXAMPLES

The following examples are put forth so as to provide those of ordinary skill in the art with a complete disclosure and description of certain examples of how the compositions and/or methods discussed herein are made and evaluated, and are intended to be purely exemplary examples of the disclosure and are not intended to limit the scope of what the inventors regard as their disclosure. However, those of skill in the art should, in light of the present disclosure, appreciate that many changes can be made in the specific embodiments which are disclosed and still obtain a like or similar result without departing from the spirit and scope of the disclosure.

### Example 1

The ability to control the release rate of nitrogen (N) from various fertilizer compositions was evaluated. A column system consisting of 36 PVC pipes with a diameter of 6-inches and a height of 40-inches were used to evaluate the effectiveness of the biochar fertilizers of the present disclosure on corn productivity in greenhouse trials. Corn seeds (5700 VT2P DG RIP, DroughtGard® Hybrids, Mustang Seeds, SD) were directly sowed in the columns, which were filled with topsoil purchased from regional farmers. After germination, seedings were thinned to keep only one seedling with similar size in each column to simulate the plant density in a field. The plants were grown under greenhouse conditions at 14 hr day/10 hr night, at about 65% humidity and 25° C. with supplemental lighting. While the use of the column had the potential to limit corn root growth, it allowed for better estimations of leaching and nitrogen use efficiency.

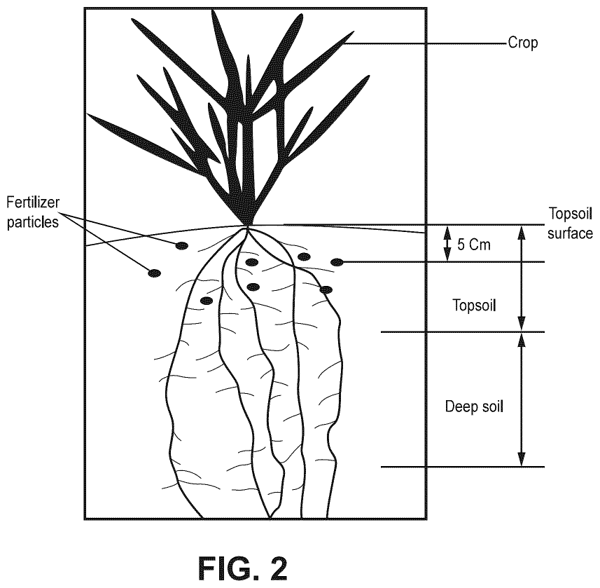

Soil mineral content was analyzed to determine the basal nitrogen level. The biochar-based fertilizer samples of the present disclosure were applied 5 cm in depth from the surface of the soil to simulate actual fertilization in farming practices at a rate that correlates to about 40,000 plants per acre and a target yield of about 250 lb of nitrogen per acre. An example of how the biochar fertilizer particles are applied in fields for crop growth is shown in FIG. 2. As will be further discussed herein, the soil moisture content, temperature, and pH value can be measured within 5 cm depth from the topsoil surface.

The analysis consisted of four treatments with nine plants per treatment. The four treatments included: (1) control—where only water was provided to the plants; (2) conventional urea fertilizer; (3) commercially-available controlled release fertilizer (Osmocote® plus, 15-9-12); and (4) a biochar fertilizer of the present disclosure. All treatments were set at a nitrogen level having a target yield of 250 bushels/acre based on the soil nitrogen content. The plants were irrigated daily to maintain well-watered conditions by adjusting irrigation level with increase in plant size and stage. The leaf number, plant height, root depth, and leaf chlorophyll index were recorded weekly (leaf chlorophyll index is directly correlated with nitrogen content in plants). The flowering times were also recorded. Leachate samples were collected every month to determine nitrogen loss through leaching. Four weeks after pollination, the plants were harvested to obtain the dry weight of corn stover, roots, total grain number/ear and weight of 100 grains. At the end of the greenhouse trials, degradation of coating materials of the biochar-based fertilizers and the residual nitrogen in the biochar-based fertilizer particles were also analyzed.

Initial results have demonstrated that the release rates of nutrients (e.g., nitrogen) of the biochar-based fertilizers of the present disclosure in water are able to be controlled at a temperature of about 25° C. and pH value of 7. Further, the release of nutrients from the biochar-based fertilizers can respond to soil conditions, including moisture content, temperature, and pH value when applied into fields under 5 cm of topsoil surface. It is expected that when the soil moisture content is increased from 10% to 80%, the release rates of nutrients (e.g., nitrogen) will show an increase ranging from about 0% to about 90% at a soil temperature of about 25° C. and a pH value of 7. It is expected that when the soil temperature is increased from 0° C. to 45° C., the release rate of nutrients (e.g., nitrogen) will show an increase ranging from about 0% to about 60% at about a 50% soil moisture content and a pH value of 7. It is expected that when the soil pH value is increased from 4 to 9, the release rate of nutrients (e.g., nitrogen) will show an increase from about 20% to about 50% at a temperature of about 25° C.

### Example 2

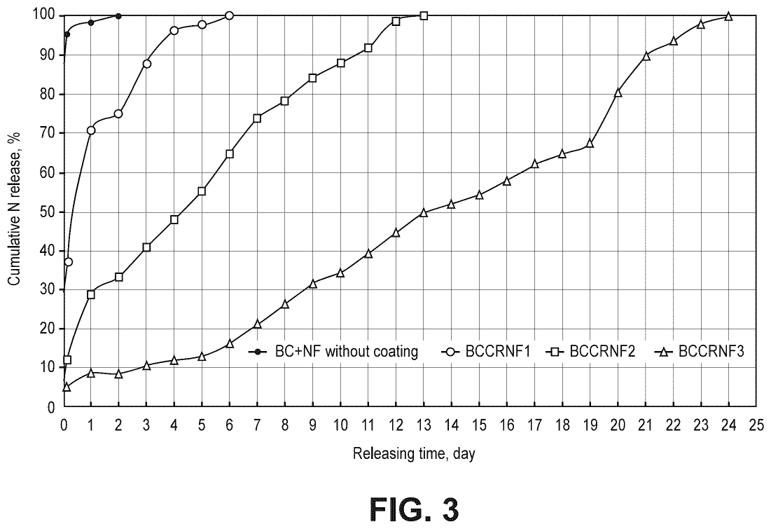

Further, the nitrogen release of various biochar-based fertilizers in water at a temperature of 25° C. and a pH value of 7 was analyzed. The various biochar-based fertilizers contained varying thicknesses of biodegradable polymer composite coating as discussed throughout the present disclosure. The results of the cumulative nitrogen release of the various biochar-based fertilizer compositions are shown in FIG. 3. The various biochar-based fertilizers evaluated within FIG. 3 included a biochar-based fertilizer without any coating (BC+NF without coating), and three biochar-based fertilizers of the present disclosure with different thicknesses of coatings (BCCRNF1=1% thickness, BCCRNF2=3% thickness, and BCCRNF3=5% thickness). As shown in FIG. 3, the biochar-based fertilizers with coatings provided a controlled and extended release of nitrogen. The results further demonstrated that the thickness of the coating may be varied depending on the release profile required for the type of crop grown.

### Example 3

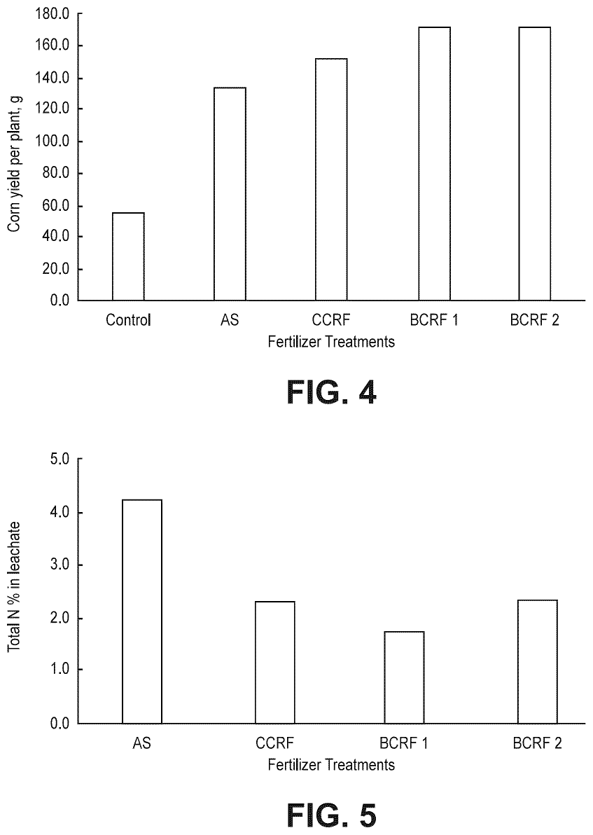

Following the methods provided in Example 1, the corn yield and loss of nitrogen due to leaching was further evaluated. The results of the corn yield in greenhouse trials is shown in FIG. 4. Within FIG. 4, the following fertilizer treatments were evaluated: (1) Control—without addition of fertilizer; (2) AS=ammonium sulfate; (3) CCRF—commercial control release fertilizer; (4) BCRF—Biochar-based controlled release fertilizer. Two BCRF formulations of the present disclosure were evaluated, BCRF 1 and FCRF 2. The formulations for BCRF 1 and BCRF 2 contained the same biochar content, however, BCRF 1 further incorporated wastewater sludge. Further, the results of nitrogen loss from leaching is shown in FIG. 5. Within FIG. 5, the fertilizer treatments evaluated included AS, CCRF, BCRF 1, and BCRF 2.

As demonstrated within FIG. 4, when the fertilizer treatments were applied at the same rate (g/m², or lbs/acre) in the corn greenhouse trials, the corn grain yield of the BCRF treatments significantly increased 28% and 13% higher than that of the conventional ammonium sulfate fertilizer and an existing commercial control release fertilizer (e.g., Osmocote® plus, 15-9-12) respectively. The results demonstrate the ability of the biochar-based fertilizers of the present disclosure to provide higher crop yields per plant in comparison to other commercially available fertilizers.

As demonstrated within FIG. 5, when the fertilizer treatments were applied at the same rate (g/m², or lbs/acre) in the corn greenhouse trials, the nitrogen loss in leaching of the BCRF treatments was about 45% lower than that of conventional ammonium sulfate fertilizer and the commercial control release fertilizer (e.g., Osmocote® plus, 15-9-12) respectively. The results demonstrate the ability of the biochar-based fertilizers of the present disclosure to provide a lower loss of nitrogen due to leaching in comparison to other commercially available fertilizers.

Although the various embodiments have been described with reference to preferred implementations, persons skilled in the art will recognize that changes may be made in form and detail without departing from the spirit and scope thereof.

1. A controlled release fertilizer comprising:
(a) a biochar mixture;
(b) one or more nutrients; and
(d) a biodegradable polymer composite coating encapsulating the biochar mixture and the one or more nutrients.

2. The controlled release fertilizer of claim 1, wherein the controlled release fertilizer comprises a plurality of particles.

3. The controlled release fertilizer of claim 2, wherein the particles have a diameter between about 0.1 mm and about 8.0 mm.

4. The controlled release fertilizer of claim 1, wherein the biochar mixture is present in an amount of from about 10% to about 90% by weight of the controlled release fertilizer.

5. The controlled release fertilizer of claim 1, wherein the biodegradable polymer composite coating comprises one or more of a synthetic polymer or natural polymer comprising bio-resins, lignin, cellulose, nanocellulose, polylactic acid (PLA), polycaprolactone (PCL), polyglycolide (PGA), polybutylene succinate (PBS), bio-asphalt, or bio-oil residues.

6. The controlled release fertilizer of claim 1, wherein the biodegradable polymer composite coating is present in an amount of from about 0.1% to about 50% by weight of the controlled release fertilizer.

7. The controlled release fertilizer of claim 1, wherein the biodegradable polymer composite coating comprises a synthetic polymer in an amount of from about 1% to about 90% by weight, a natural polymer in an amount of from about 1% to about 80% by weight, and one or more additives in an amount of from 0% to about 50% by weight of the biodegradable polymer composite coating.

8. The controlled release fertilizer claim of 1, further comprising one or more of alginate, kaolin, and waste water sludge.

9. The controlled release fertilizer of claim 8, wherein the alginate is present in an amount of from 0% to about 30% by weight, wherein the kaolin is present in an amount of from 0% to about 25% by weight, or wherein the waste water sludge is present in an amount of from 0% to about 60% by weight of the controlled release fertilizer.

10. The controlled release fertilizer of claim 1, wherein the one or more nutrients comprises one or more of nitrogen, potassium, and phosphorus.

11. The controlled release fertilizer of claim 10, wherein the nitrogen is present in an amount of from 0% to about 55% by weight, wherein the potassium is present in an amount of from 0% to about 65% by weight, and/or wherein the phosphorus is present in an amount of from 0% to about 40% by weight of the controlled release fertilizer.

12. The controlled release fertilizer of claim 1, wherein a release rate of the one or more nutrients from the controlled release fertilizer depends on one or more conditions of a soil, the one or more conditions of the soil comprising moisture content, temperature, and/or pH value.

13. The controlled release fertilizer of claim 1, further comprising a biosolid in an amount of from 0% to about 60% by weight of the controlled release fertilizer.

14. A method of making a biochar based controlled release fertilizer comprising:
mixing together a biochar mixture and one or more nutrients; and
encapsulating the biochar mixture and the one or more nutrients in a biodegradable polymer composite.

15. The method of claim 14, further comprising pelletizing the biochar mixture and the one or more nutrients.

16. The method of claim 14, wherein the biodegradable polymer composite comprises one or more of a synthetic or natural polymer comprising bio-resins, lignin, cellulose, nanocellulose, polylactic acid (PLA), polycaprolactone (PCL), polyglycolide (PGA), polybutylene succinate (PBS), bio-asphalt, or bio-oil residues.

17. The method of claim 14, wherein the one or more nutrients comprises one or more of nitrogen, potassium, and phosphorus.

18. The method of claim 14, further comprising mixing one or more of alginate, kaolin, and waste water sludge with the biochar mixture and the one or more nutrients.

19. A method of using a biochar based controlled release fertilizer comprising:
applying the controlled release fertilizer according to claim 1 to soil.

20. The method of claim 19, wherein the controlled release fertilizer provides a controlled release of the one or more nutrients from the controlled release fertilizer depending on one or more conditions of the soil, wherein the one or more conditions of the soil comprises moisture content, temperature, and/or pH value.
